(19) United States
(12) Patent Application Publication
(10) Pub. No.: US 2013/0085197 A1
(43) Pub. Date: Apr. 4, 2013

(54) DISPERSION COMPRISING A LIQUID PHASE AND A SOLID PHASE

(71) Applicants: Dejan PETROVIC, Ludwigshafen (DE); Berend Eling, Lemfoerde (DE); Zeljko Tomovic, Lemfoerde (DE)

(72) Inventors: Dejan PETROVIC, Ludwigshafen (DE); Berend Eling, Lemfoerde (DE); Zeljko Tomovic, Lemfoerde (DE)

(73) Assignee: BASF SE, Ludwigshafen (DE)

(21) Appl. No.: 13/599,390

(22) Filed: Aug. 30, 2012

Related U.S. Application Data
(60) Provisional application No. 61/530,414, filed on Sep. 2, 2011.

(51) Int. Cl. C08K 3/36; C08L 75/04

(52) U.S. Cl. CPC C08K 3/36; C08L 75/04
USPC 521/137; 524/566; 524/507

(57) ABSTRACT

Dispersions comprise a liquid phase and a solid phase.

The present invention relates to dispersions comprising a liquid phase and a solid phase.

Polymer-filled polyols, also known as “graft polyols” or “polymer polyols”, are used in the polyurethane (PU) industry as a raw material in order to enhance the hardness and compressive strength of foamed materials. Similarly, the cell-opening process in the production of open-cell foams is augmented by using such filled polyols. Although such filled polyols are predominantly used in the flexible foam sector, there are also possible applications in the microcellular foam sector, for example shoe soles.

Polymer-filled polyols are generally polyetherols filled with a copolymer of styrene and acrylonitrile, for example, but there are also polymer-filled polyester polyols. The method of producing these products generally comprises styrene and acrylonitrile being polymerized in the polyetherol in the presence of a macromonomer (styrene-acrylonitrile polymer, SAN). The organic filler content of the polyol is generally 30-50% by weight.

Prior art in the field of graft polyols is summarized for example in chapter 6 of M. Ionescu, Chemistry and technology of polyols for polyurethanes, Rapra Technology, 2005.

In the context of the present disclosure, the term “polyol” refers to a compound having at least two Zerewitininoff-active hydrogen atoms, for example with two or more than two reactive hydroxyl groups.

Graft polyol technology utilizes two main types of polyether polyols as carrier polyols in the production of polymer polyols: reactive polyols and slabstock polyols. These polyols differ in molecular weight and chain construction. Reactive polyols have a molecular weight of 1000-8000 g/mol, preferably in the range from 2000 to 6000 g/mol and comprise an inner block, based on propylene oxide monomers, and an end block, based on ethylene oxide, the ethylene oxide fraction in the polyol being between 13 and 20%. Slab stock polyols are poly(ethylene/propylene oxide) copolymers having an ethylene oxide content of 5-15% and have a molecular weight of 2500-3500 g/mol. Slab stock polyols generally have >90% secondary end-hydroxyl groups.

The term “macromer” in the context of the present invention designates a compound having at least one hydroxyl group and at least one unsaturated bond, especially a polyetherol having at least one ethylenically unsaturated bond and at least one hydroxyl group.

The macromer performs the function of sterically stabilizing the SAN particles which form and thereby inhibits SAN particle agglomeration or flocculation. Furthermore, particle sizes can be adjusted to specific values via the amount of macromer used. Particle size is generally between 0.1 and 5 μm.

Macromers used are typically polyfunctional polyetherols subsequently provided with an unsaturated bond free-radically polymerizable with the monomers. A known process for this, Macromers used are typically polyfunctional polyetherols subsequently provided with an unsaturated bond free-radically polymerizable with the monomers. A known process for this, also described in EP 0776 922 B1 or WO 99031160 A1 for example, is the functionalization of hydroxyl-containing polyetherols with dimethyl-meta-isopropenylbenzyl isocyanate (TMI). Reacting a polyetherol with TMI, as will be known, is effected here using catalysts to speed the reaction of the isocyanate with the OH group of the polyetherol. The best known example here is dibutyltin dilaurate (DBTL), which has turned out to be very efficient in this reaction and thus is also used on a large industrial scale.

Graft polyol phase stability and viscosity are greatly dependent on the macromer used to surface-stabilize the polymer particles. The copolymerization of the macromer with the monomers (e.g., styrene, acrylonitrile) plays an important part in the formation of polymeric stabilizing structures. The macromer structure has to be conformed to the carrier polyol to achieve optimum stabilization and the lowest possible viscosity for a given solids content.

It is a general problem that a macromer which offers efficacious stabilization in one particular polyol can usually not be used for making stable dispersions in other carrier polyols, at any rate when these carrier polyols clearly differ in the polarity, the PO (propylene oxide)/EO (ethylene oxide) ratio, the OH number, the chain length and/or the functionality of the polyol starter. For example, a macromer based on sorbitol-POₓ-polyol (OH number 20 mg KOH/g) can be used to make stable SAN dispersions in a typical slab stock polyol, but in short-chain polyols having a high OH number (e.g., rigid foam polyols and chain extenders such as, for example, ethylene glycol, 1,4-butanediol and 1,6-hexanediol, short-chain diols, etc.) the same macromer does not deliver stable dispersions.

Schmid et al., Langmuir 2005, 21, 8103-8105 describes the synthesis of silica-stabilized polystyrene latex particles. A styrene monomer is polymerized in an alcoholic silica sol (methanol or 2-propanol); a silica-stabilized polystyrene latex particle having a diameter of about 1 to 3 μm is obtained.

DE102009001595 describes improving the stabilization of mutually immiscible polyols by adding particles and carrier media as compatibilizing agents.

WO 2010/103072 A1 discloses a process for preparing silica-containing dispersions comprising a polyetherol or a polyetheramine by admixing an aqueous silica sol with a polyetherol and/or polyetheramine, distilling the water off and admixing the dispersion with a compound having an alkoxylated silyl group for example.

WO 2010/043530 further describes a process for production of silicate-containing polyols by admixing an aqueous silica sol with an organic solvent, admixing the resulting mixture with a polyol, distilling the organic solvent and water off at least partly, admixing with a further compound, and optionally adjusting the pH.

A universally useful and economical process for preparing stable polymer dispersions in a wide variety of polyols is nevertheless hitherto unknown from the prior art. More particularly, steric stabilization of polymer particles in chain extenders (such as ethylene glycol, 1,4-butanediol, 1,6-hexanediol, short-chain diols, etc.) is not achievable using macromers.

As mentioned, in every individual case, specific macromers have to be used for a particular polyol; thus, one particular macromer can only be used for particular polyols. With some polyols, it has hitherto even been impossible to find a fitting macromer at all to stabilize the graft particles, for example in short-chain polyols having a high OH number, e.g., in rigid foam polyols and chain extenders.

It was an object of the present invention to overcome the abovementioned problems and to provide such a universally useful process for preparing stable dispersions in a wide variety of polyols. It was a further object of the present invention to provide a stable dispersion comprising a continuous phase and a solid phase.

It has now been found that, surprisingly, the problems mentioned are solved by using inorganic particles.

These particles offer efficacious steric stabilization of polymer particles irrespective of the choice of carrier polyol. These particles can have differing shape: ball-, rod- and platelet-shaped. One essential feature of these particles is that their size is in the range of the dispersed polymer particles or below, i.e., generally less than 5 micrometers. A further feature of the inorganic particles is that at least one of the dimensions is in the nanosize range, i.e., at least one and preferably all the dimensions has/have a size of 1 to 100 nm. The inorganic particles can be in the form of primary particles or else in the form of an agglomerated structure. These particles are dispersed in the polyol or a mixture consisting of polyol and monomer before and/or during the production of the polymer particles, so that they can deploy their stabilizing effect during the polymerization of the monomers and during the formation of the polymer particles. It is also possible to add the particles in the form of a solution, for example an aqueous solution, in which case the solvent, for example water, is removed at the end.

Without wishing to be bound to any one theory, we believe that the inorganic particles diffuse to the interface formed by the precipitation of the polymer from the continuous phase, and develop their phase-stabilizing effect there. The inorganic particles can be situated on the surfaces of the polymeric particles, but can also be situated in the inner body of the particle. The inorganic particles used display an interface-stabilizing effect during the process for producing the polymer-filled polyol, and also an improvement in storage stability for the polymer polyol produced.

It is believed that, during the formation of the dispersion, some of the inorganic particles become arrayed in the boundary layer between the organic polymer and the compound having at least two Zerewitinoff-active hydrogen atoms, efficaciously stabilizing the newly formed polymer particles against coalescing. This leads to the formation of hybrid organic-inorganic particles which have long-term stability in a wide selection of polyols. Therefore, the process of the present invention offers a universal and economical process for producing stable dispersions in a wide range of polyols.

The present invention accordingly provides a dispersion comprising a continuous phase (C) and a phase which is solid at 20° C. and dispersed in the continuous phase, wherein the continuous phase (C) comprises at least one compound having at least two Zerewitinoff-active hydrogen atoms, and the solid phase comprises at least one filler, wherein the filler is a hybrid material which in each case comprises at least one organic polymer (P) and at least one inorganic particle.

One embodiment of the invention is a dispersion consisting of a continuous phase (C) and a phase which is solid at 20° C. and dispersed in the continuous phase, wherein the continuous phase (C) comprises at least one compound having at least two Zerewitinoff-active hydrogen atoms, and the solid phase comprises at least one filler, wherein the filler is a hybrid material which in each case comprises at least one organic polymer (P) and at least one inorganic particle.

The inorganic particle has an average maximum diameter of at most 5 μm and preferably at most 1 μm, wherein at least one and preferably all of the dimensions of the inorganic particle is/are in the range of 1-100 nm.

In one preferred embodiment, the dispersion of the present invention comprises from 10% to 60% by weight and preferably from 20% to 50% by weight of solid phase, based on the entire dispersion.

In one preferred embodiment, the hybrid material comprises from 0.1% to 50% by weight, preferably from 0.5% to 25% by weight and more preferably from 2% to 15% by weight of inorganic particles and from 50% to 99.9% by weight of organic polymer (P).

In one preferred embodiment, the hybrid material consists in each case of at least one organic polymer (P) and at least one inorganic particle.

In one embodiment of the dispersion according to the present invention, the organic polymer (P) in the hybrid material is selected from the group comprising polystyrene, poly(styrene-co-acrylonitrile), polyacrylonitrile, polyacrylate, polymethacrylate, polyolefins, e.g., polypropylene, polyethylene, polyisobutylene, polybutadiene, polyesters, polyamide, polyvinyl chloride, polyethylene terephthalate, polyvinyl acetate, polyethylene glycol, polyurethane, polyurea and mixtures thereof, preferably consisting of poly(styrene-co-acrylonitrile), polyacrylonitrile and mixtures thereof.

In one preferred embodiment of the dispersion according to the present invention, the organic polymer (P) in the hybrid material is selected from the group consisting of polystyrene, poly(styrene-co-acrylonitrile), polyacrylonitrile, polyacrylate, polymethacrylate, polyolefins, e.g., polypropylene, polyethylene, polyisobutylene, polybutadiene, polyesters, polyamide, polyvinyl chloride, polyethylene terephthalate, polyvinyl acetate, polyethylene glycol, polyurethane, polyurea and mixtures thereof, preferably consisting of poly(styrene-co-acrylonitrile), polyacrylonitrile and mixtures thereof.

The inorganic particles in the hybrid material can be, in accordance with the present invention, semimetal oxides, metal oxides (for example oxides of the following metals: Zn, Al, Si, Fe, Ti, B, Zr, V, etc.), mixed oxides, carbides, nitrides, carbonates (e.g., CaCO₃), hydroxides, carbon (such as, for example, graphite, graphene, nanotubes, fibers), inorganic salts, inorganic pigments, silicates, silicone resins, silicones and/or silica, or mixtures thereof, in which case these recited classes of particles may all optionally be surface modified, for example hydrophobicized or hydrophilicized. The examples of useful hydrophobicizers include at least one compound from the group of silanes, siloxanes, quaternary ammonium compounds, cationic polymers and fatty acids and anions thereof. Examples of carbon-based particles are graphite, graphene, nanotubes, fibers, carbon black. Examples of silicate-based particles are sheet-silicate, silica sol or aerogel.

Useful inorganic particles for the purposes of this invention include inter alia various silicate materials. Silicate materials of differing origin can be used for this, for example silica sol, in which case silica can be dispersed in water, (mono)alcohol or in a polyol, surface-functionalized silica sols, sheet-silicates, pyrogenous silica, etc.

Examples of commercially available silica materials useful for the purposes of the present invention are Laponit® synthetic sheet-silicate, Optigel® natural sheet-silicate, Levasil® silica sol, Aerosil® pyrogenous silica.

Primary particles are generally to be understood as meaning the particles in the source state, i.e., just as-nucleated and before the onset of agglomeration events. Prominent examples of agglomerates constructed of primary particles are for instance pyrogenous silica (aerosil) and carbon black. Carbon black, for example, consists of minutest, usually spherical primary particles usually having a size of 10-300 nm. These primary particles have coalesced into chain-shaped aggregates which are lumplike in some instances. Many of these aggregates combine to form agglomerates. The agglomerates can no longer be defined as primary particles. By varying the production conditions not only the size of primary corpuscles but also their degree of aggregation can be adjusted in a specific manner.

Preference is given to silicate-based particles such as aerosil particles and especially silica sol particles. Aerosils in polyol are described for example in DE102009001595. WO 2010/103072 and WO 2010/043530 describe for example various dispersions based on polyols and polyetheramines as carrier medium and silica sol particles as disperse phase, wherein the particles are partly modified with different silanes.

The silicon dioxide in the silicon dioxide dispersions of the present invention is preferably modified with at least one silane (S). The modification with the silane (S) takes place at the surface of the silicon dioxide particles in the (respective) silicon dioxide dispersions of the present invention. Methods of surface modification (also known as silanization) are known as such to a person skilled in the art. There is a large choice of various silanes (S).

Preferably, the silane (S) additionally has at least one silyl group which is at least singly alkoxylated. Optionally, silane (S) may also comprise two or more silyl groups which are each in turn at least singly alkoxylated. Preference is given to a silane (S) which has exactly one at least singly alkoxylated silyl group, for example a singly to triply, preferably doubly to triply and more preferably triply alkoxylated silyl group.

In addition, the silane (S) may have at least one alkyl, cycloalkyl and/or aryl substituent (radicals), in which case these substituents may optionally comprise ethylenically unsaturated groups and/or further heteroatoms, such as O, S or N. The use of silanes comprising ethylenically unsaturated groups may be co-incorporated in the polymer in the case of free-radically produced hybrid dispersions.

Although it is not absolutely necessary for the silica sol particles to be silanized, silanization may contribute to the further stabilization of the forming of the hybrid dispersion during the synthesis and storage stability of the hybrid dispersion.

According to the present invention, the continuous phase (C) preferably has a water content below 5% by weight, more preferably below 1% by weight and even more preferably below 0.2% by weight.

The continuous phase (C) comprises, in accordance with the present invention, at least one compound having at least two Zerewitinoff-active hydrogen atoms.

In one embodiment, the continuous phase (C) consists of at least one compound having at least two Zerewitinoff-active hydrogen atoms.

In one embodiment, the continuous phase (C) comprises exactly one compound having at least two Zerewitinoff-active hydrogen atoms.

In a further embodiment, the continuous phase (C) comprises more than one compound having at least two Zerewitinoff-active hydrogen atoms.

In one embodiment, the continuous phase (C) comprises less than ten and preferably less than three compounds having at least two Zerewitinoff-active hydrogen atoms.

In one embodiment of the dispersion according to the present invention, the compound having at least two Zerewitinoff-active hydrogen atoms is selected from the group comprising polyether polyols, chain extenders, polyester polyols, polyether-polyester polyols, polycarbonate polyols, polyetheramines and mixtures thereof.

In one embodiment of the dispersion according to the present invention, the compound having at least two Zerewitinoff-active hydrogen atoms is selected from the group consisting of polyether polyols, chain extenders, polyester polyols, polyether-polyester polyols, polycarbonate polyols, polyetheramines and mixtures thereof.

In one preferred embodiment of the hybrid dispersion according to the present invention, the compound having at least two Zerewitinoff-active hydrogen atoms is a polyether polyol, chain extenders, a polyetheramine or a polyester polyol.

Polyetherols are for example poly-THF polyols or polyalkoxides based on propylene oxide, ethylene oxide, butylene oxide or styrene oxide, or mixtures thereof.

In one particularly preferred embodiment of the hybrid dispersion according to the present invention, the compound having at least two Zerewitinoff-active hydrogen atoms is a polyether polyol.

In a very particularly preferred embodiment of the dispersion according to the present invention, the compound having at least two Zerewitinoff-active hydrogen atoms is a polyether polyol having a molecular weight (Mn) of 200-12 000 g/mol and preferably 300-6000 g/mol and/or an OH number of 10-1000 mg KOH/g and preferably 25-500 mg KOH/g, and/or a polyol starter functionality of 2-8 and preferably 2-6.

The polyether polyols which are usable according to the present invention are prepared by known processes. For example, they are obtainable by anionic polymerization with alkali metal hydroxides, for example sodium hydroxide or potassium hydroxide or alkali metal alkoxides, for example sodium methoxide, sodium ethoxide, potassium ethoxide or potassium isopropoxide as catalysts and under addition of at least one starter molecule having 2 to 8 and preferably 2 to 6 reactive hydrogen atoms, or by cationic polymerization with Lewis acids, such as antimony pentachloride, boron fluoride etherate among others or fuller's earth as catalysts. Similarly, polyhydroxy compounds are obtainable by double metal cyanide catalysis, from one or more alkylene oxides having 2 to 4 carbon atoms in the alkylene moiety. Tertiary amines can also be used as a catalyst, examples being triethylamine, tributylamine, trimethylamine, dimethylethanolamine, imidazole or dimethylcyclohexylamine. For specialty applications, monofunctional starters can also be included in the polyether construction.

Suitable alkylene oxides are for example tetrahydrofuran, 1,3-propylene oxide, 1,2-butylene oxide, 2,3-butylene oxide, styrene oxide and preferably ethylene oxide and 1,2-propylene oxide. The alkylene oxides can be used individually, alternatingly in succession or as mixtures.

Useful starter molecules include for example: water, aliphatic and aromatic, optionally N-monoalkyl-, N,N- and N,N′-dialkyl-substituted diamines having 1 to 4 carbon atoms in the alkyl moiety, such as optionally mono- and dialkyl-substituted ethylenediamine, diethylenetriamine, triethylenetetramine, 1,3-propylenediamine, 1,3-butylenediamine, 1,4-butylenediamine, 1,2-hexamethylenediamine, 1,3-hexamethylenediamine, 1,4-hexamethylenediamine, 1,5-hexamethylenediamine, 1,6-hexamethylenediamine, phenylenediamine, 2,3-, 2,4- and 2,6-tolylenediamine (TDA) and 4,4′-, 2,4′- and 2,2′-diaminodiphenylmethane (MDA) and polymeric MDA. Useful starter molecules further include: alkanolamines, for example ethanolamine, N-methyl- and N-ethyl-ethanolamine, dialkanolamines, for example diethanolamine, N-methyl- and N-ethyldiethanolamine, trialkanolamines, for example triethanolamine, and ammonia. Preference is given to using polyhydric alcohols, such as ethanediol, 1,2-propanediol, 2,3-propanediol, diethylene glycol, dipropylene glycol, 1,4-butanediol, 1,6-hexanediol, glycerol, trimethylolpropane; pentaerythritol, sorbitol and sucrose, and mixtures thereof.

The polyether polyols, preferably polyoxypropylene and polyoxypropylenepolyoxyethylene polyols, have a functionality of preferably 2 to 8 and average molecular weights of 200 to 12 000 g/mol and preferably 300 to 6000 g/mol.

Useful polyether polyols further include polytetrahydrofuran (poly-THF polyols). The number average molecular weight of the polytetrahydrofuran is typically in the range from 550 to 4000 g/mol, preferably in the range from 750 to 3000 g/mol, and more preferably in the range from 800 to 2500 g/mol.

The polyhydroxy compounds, especially polyether polyols, can be used individually or in the form of mixtures.

In addition to the polyether polyols described, it is also possible to use for example polyether polyamines and/or further polyols selected from the group of polyester polyols, polythioether polyols, polyester amides, hydroxyl-containing polyacetals and hydroxyl-containing aliphatic polycarbonates and acrylates or mixtures of two or more thereof.

Polyetheramines and their preparation are described for example in U.S. Pat. No. 4,286,074 A or WO 2010/133630.

Chain extenders used are preferably compounds having a molecular weight of less than 600 g/mol, for example compounds having 2 isocyanate-reactive hydrogen atoms. These can be used individually or alternatively in the form of mixtures. Preference is given to using diols having molecular weights less than 300 g/mol. Useful are for example aliphatic, cycloaliphatic and/or araliphatic diols having 2 to 14 and preferably 2 to 10 carbon atoms, especially alkylene glycols. Therefore, low molecular weight hydroxyl-containing polyalkylene oxides based on ethylene oxide and/or 1,2-propylene oxide are also suitable. Preferred chain extenders are (mono)ethylene glycol, 1,2-propanediol, 1,3-propanediol, pentanediol, tripropylene glycol, 1,10-decanediol, 1,2-dihydroxycyclohexane, 1,3-dihydroxycyclohexane, 1,4-dihydroxycyclohexane, diethylene glycol, triethylene glycol, dipropylene glycol, 1,4-butanediol, 1,6-hexanediol, 2-methylpropane-1,3-diol, 2,2-dimethylpropane-1,3-diol, bisphenol A bis(hydroxyether), ethanolamine, N-phenyldiethanolamine, phenylenediamine, diethyltoluenediamine, polyetheramines and bis(2-hydroxyethyl)hydroquinone.

Particular preference for use as chain extenders is given to monoethylene glycol, diethylene glycol, 2-methyl-1,3-propanediol, 1,4-butanediol, 1,5-pentanediol, 1,6-hexanediol or mixtures thereof, while 1,4-butanediol and/or monoethylene glycol are/is very particularly preferred.

Polyester polyols are prepared for example from alkanedicarboxylic acids and polyhydric alcohols, polythioether polyols, polyester amides, hydroxyl-containing polyacetals and/or hydroxyl-containing aliphatic polycarbonates, preferably in the presence of an esterification catalyst. Further possible polyols are indicated for example in chapter 3.1 of “Kunststoffhandbuch, volume 7, Polyurethanes”, Carl Hanser Verlag, 3^{rd} edition 1993. The polyester polyols preferably used are obtainable for example from dicarboxylic acids having 2 to 12 carbon atoms and preferably 4 to 6 carbon atoms, and polyhydric alcohols. Useful dicarboxylic acids include for example: aliphatic dicarboxylic acids, such as succinic acid, glutaric acid, adipic acid, suberic acid, azelaic acid and sebacic acid and aromatic dicarboxylic acids, such as phthalic acid, isophthalic acid and terephthalic acid. Dicarboxylic acids can be used individually or as mixtures, for example in the form of a succinic, glutaric and adipic acid mixture. To prepare polyesterols it can possibly be advantageous to replace the dicarboxylic acids by the corresponding dicarboxylic acid derivatives, such as dicarboxylic esters having 1 to 4 carbon atoms in the alcohol moiety, dicarboxylic anhydrides or dicarbonyl chlorides. Examples of polyhydric alcohols are glycols having 2 to 10 and preferably 2 to 6 carbon atoms, such as ethylene glycol, diethylene glycol, 1,4-butanediol, 1,5-pentanediol, 1,6-hexanediol, 1,10-decanediol, 2,2-dimethyl-1,3-propanediol, 1,3-propanediol and dipropylene glycol, triols having 3 to 6 carbon atoms, for example glycerol and trimethylolpropane, and pentaerythritol as an example of a more highly hydric alcohol. Depending on the desired properties, the polyhydric alcohols can be used alone or optionally in mixtures with each or one another.

The dispersions of the present invention are obtainable in at least two different ways: (1) by free-radical polymerization or (2) by melt emulsification.

### (1) Free-Radical Polymerization

The present invention accordingly further also provides a process (V1) for preparing a dispersion which is in accordance with the present invention, which comprises free-radically polymerizing at least one ethylenically unsaturated monomer (A) in a continuous phase (C) in the presence of at least one inorganic particle, preferably having an average maximum diameter of at most 5 μm for the particles, wherein preferably at least one of the dimensions of the inorganic particle is in the range of 1-100 nm, by addition of a reaction moderator, a free-radical initiator, and optionally further components. A macromer is an example of a possible optional further component.

Macromer here is to be understood as meaning a compound having at least one hydroxyl group and at least one unsaturated bond, especially a polyetherol which has at least one ethylenically unsaturated bond and at least one hydroxyl group.

Details concerning macromers also appear in M. Ionescu, Chemistry and technology of polyols for polyurethanes, Rapra Technology, 2005, chapter 6, especially chapter 6.2.2. The dibutyltin dilaurate (DBTL) catalyst typically used here can also be replaced by catalysts based on zinc carboxylate and/or bismuth carboxylate.

If at least one macromer is used in addition to the at least one inorganic particle, then it is generally in an amount up to 10% by weight, based on the amount of ethylenically unsaturated monomer (A).

The ethylenically unsaturated monomers (A) are generally monofunctional, but they may also have a higher functionality. Styrene and divinylbenzene may be mentioned by way of example. The incorporation of monomers having a functionality of 2 or more results in a crosslinking of the polymer. Covalent crosslinking of the organic polymer and hence also for the dispersion of the present invention leads to higher thermal stability of the dispersed particles, which can later have advantages in use.

In one embodiment of the process according to the present invention, the ethylenically unsaturated monomers (A) are selected from the group comprising styrene, alpha-methylstyrene, acrylonitrile, acrylamide, (meth)acrylic acid, (meth)acrylic esters, hydroxyalkyl(meth)acrylates, vinyl ethers, allyl ethers, divinylbenzene and mixtures thereof. In a further embodiment of the process according to the present invention, the ethylenically unsaturated monomers (A) are selected from the group consisting of styrene, alpha-methylstyrene, acrylonitrile, acrylamide, (meth)acrylic acid, (meth)acrylic esters, hydroxyalkyl(meth)acrylates, vinyl ethers, allyl ethers, divinylbenzene and mixtures thereof.

In this context, the continuous phase (C) is exactly as already defined above, including preferred embodiments of the continuous phase (C).

The inorganic particles, inclusive of preferred embodiments, are likewise subject to the above observations.

In one embodiment of the invention, the reaction moderator is selected from the group consisting of OH- and/or SH-functional compounds, such as alcohols, for example 1-butanol, 2-butanol, isopropanol, ethanol, methanol, and/or mercaptans such as ethanethiol, 1-heptanethiol, 2-octanethiol, 1-dodecanethiol, thiophenol, 2-ethylhexyl thioglycolate, methyl thioglycolate, cyclohexyl mercaptan, and also enol ether compounds, morpholines and α-(benzoyloxy)styrene. The reaction moderator is preferably selected from the group consisting of monofunctional alcohols and alkyl mercaptans. The use of alkyl mercaptans is particularly preferred.

A useful free-radical initiator typical comprises peroxy or azo compounds, such as dibenzoyl peroxide, lauroyl peroxide, t-amyl peroxy-2-ethylhexanoate, di-tert-butyl peroxide, diisopropyl peroxycarbonate, tert-butyl peroxy-2-ethylhexanoate, tert-butyl perpivalate, tert-butyl perneodecanoate, tert-butyl perbenzoate, tert-butyl percronoate, tert-butyl perisobutyrate, tert-butyl peroxy-1-methylpropanoate, tert-butyl peroxy-2-ethylpentanoate, tert-butyl peroxyoctanoate and di-tert-butyl perphthalate, 2,2′-azo(2,4-dimethylvaleronitrile), 2,2′-azobisisobutyronitrile (AIBN), dimethyl 2,2′-azobisisobutyrate, 2,2′-azobis(2-methylbutyronitrile) (AMBN), 1,1′-azobis(1-cyclohexanecarbonitrile), and mixtures thereof. The proportion of initiators is typically in the range from 0.1% to 6% by weight, based on the total weight of monomers used for preparing the polymer polyol.

In one embodiment of the process according to the present invention, the reaction moderator is selected from the group consisting of monofunctional alcohols, alkyl mercaptans and mixtures thereof, and/or the free-radical initiator is selected from the group consisting of peroxy or azo compounds and mixtures thereof.

Optionally, at least one macromer can also be used additionally to the inorganic particles.

The free-radical polymerization may, in accordance with the present invention, also be effected as a seed process, in which case a polymer polyol dispersion having a multimodal corpuscle size distribution is obtained, as described in EP 1,487,895 A1 for example.

The temperature during the free-radical polymerization is generally in the range from 60° to 140° C. and preferably in the range from 80° to 130° C.

The process can be carried out as a semi-batch process or continuously. After the reaction has ended, unconverted monomers are generally removed by stripping.

The present invention further provides dispersions obtainable by the present process for production of dispersions, which comprises free-radically polymerizing at least one ethylenically unsaturated monomer (A) in a continuous phase (C) in the presence of at least one inorganic particle by addition of a reaction moderator, a free-radical initiator, and optionally further components.

### (2) Melt Emulsification

The present invention further also provides a process (V2) for preparing a dispersion that is in accordance with the present invention, comprising the steps of:

heating a mixture (I) comprising at least one meltable polymer (P), at least one continuous phase (C) and at least one inorganic particle and optionally further components, preferably having an average maximum diameter for the particles of preferably in each case at most 5 μm,
wherein at least one of the dimensions of the inorganic particle is in the range of 1-100 nm,
commixing so that at least one meltable polymer when molten is preferably present in the mixture (I) in the form of finely divided droplets,
cooling the mixture (I).

In this context, the continuous phase (C) is exactly as already defined above, including preferred embodiments of the continuous phase (C).

The optional further components can be stabilizers for example. The optional further components generally account for up to 10% by weight of the entire dispersion.

The inorganic particles, inclusive of preferred embodiments, are likewise subject to the above observations.

The meltable polymer, including preferred embodiments, is selected from the group already given above for the organic polymer (P) in one embodiment of the process according to the present invention.

In one embodiment of the process according to the present invention, the process for producing a dispersion which is in accordance with the present invention consists of the recited steps.

As soon as the continuous phase and the disperse phase comprising the molten solid have been combined with each other, the composition is herein also referred to as crude emulsion. The crude emulsion can then be treated in an emulsifying apparatus wherein the droplets become finely emulsified. The operation of finely emulsifying can be carried out batchwise, for example in a stirred container, or continuously. Continuous machines and apparatuses for emulsifying are known to a person skilled in the art and include for example colloid mills, sprocket disperses, twin-screw extruders, or other forms of dynamic mixers, also high-pressure homogenizers, pumps with downstream nozzles, valves, membranes or other narrow slit-type geometries, static mixers, micromix systems and also ultrasonic systems of emulsification. Preference is given to using sprocket dispersers, twin-screw extruders or high-pressure homogenizers, and combinations thereof.

After the process of finely emulsifying, the fine emulsion can be cooled down to below the melting point/glass transition temperature T_{g} or the melting range of the meltable solid. In the process, the solid in the disperse phase solidifies in particulate form.

Suitable methods of melt emulsification are described for example in Schultz S., Wagner G., Urban K., Ulrich J., Chem. Eng. Technol. 2004, 27, No. 4, 361-368, “High-pressure homogenization as a process for emulsion formation”, in Urban K., Wagner G., Schaffner D., Roglin D., Ulrich J., Chem. Eng. Technol. 2006, 29, No. 1, 24-31, “Rotor-stator and disc systems for emulsification processes” and in EP 1 008 380 B1.

According to the present invention, the temperature in the first step of the process (heating) is above the melting temperature/glass transition temperature T_{g} of the at least one meltable solid, especially thermoplastic polymer (P).

According to the present invention, it is also possible for the heating in the first step of the process to be carried out in an extruder, preferably in a twin-screw extruder.

The present invention further also provides for the use of a dispersion that is in accordance with the present invention for production of polyurethanes (PUs), or as paint raw material for the automotive industry, as dispersion raw material for architectural coatings, sealant composition, cement, paper, textile, adhesive raw material, as power fuel additive or roof coating, for polishing of surfaces or for use in epoxy systems.

The dispersions of the present invention and the hybrid dispersions obtainable by a process according to the present invention are especially useful for the production of polyurethanes.

The present invention accordingly also provides for the use of a dispersion as described above, or of a dispersion obtainable by a process as described above, for production of polyurethanes.

Polyurethane for the purposes of the present invention comprises all known polyisocyanate polyaddition products, such as polyureas for example.

These comprise more particularly massive polyisocyanate polyaddition products, such as thermosets, polyurethane casting resins or thermoplastic polyurethanes, and foamed materials based on polyisocyanate polyaddition products, such as flexible foams, semirigid foams, rigid foams or integral foams and also polyurethane coatings and binders. Polyurethanes for the purposes of the present invention are further to be understood as meaning polymer blends comprising polyurethanes and further polymers, and also foamed materials formed from these polymer blends.

The dispersions obtainable according to the invention may preferably be used in flexible polyurethane foam formulations, in rigid polyurethane foam formulations, in integral polyurethane foam formulations, in polyurethane shoe formulations, in polyurethane elastomer formulations, in polyurethane casting resin formulations, in thermoplastic polyurethane formulations or in microcellular polyurethane foams.

Polyurethanes, their properties and uses are reviewed for example in “Kunstoffhandbuch, volume 7, Polyurethanes” (Carl-Hanser-Verlag, 3^{rd} edition 1993).

Processes and feedstocks for the production of polyurethanes are known in principle to a person skilled in the art. Typically, at least one polyol component and/or polyetheramine component and at least one polyisocyanate are reacted.

Therefore, the present invention also provides a process for preparing a polyurethane by reacting at least one dispersion as described above or dispersion obtainable according to any one of the processes described above with at least one polyisocyanate.

Polyurethanes are more particularly prepared according to the present invention by reacting organic and/or modified organic polyisocyanates with the above-described dispersions of the present invention and optionally further compounds having isocyanate-reactive hydrogen atoms, in the presence of catalysts, optionally water and/or other blowing agents and optionally further auxiliary and added substances.

According to the present invention, the hybrid dispersion of the present invention, or the dispersion obtainable by a process according to the present invention, can be used alone or together with at least one further polyol or together with at least one graft polyol or together with at least one further polyol and at least one graft polyol.

Specific observations concerning the further starting components usable in addition to the dispersions of the present invention follow.

Useful polyisocyanates according to the present invention include in principle any polyisocyanates known to a person skilled in the art, especially aliphatic, cycloaliphatic, araliphatic and preferably aromatic polyfunctional isocyanates.

Suitable are for example: alkylene diisocyanates having 4 to 12 carbon atoms in the alkylene moiety, such as 1,12-dodecane diisocyanate, 2-ethyl-1,4-tetramethylene diisocyanate, 2-methyl-1,5-pentamethylene diisocyanate, 1,4-tetramethylene diisocyanate and preferably 1,6-hexamethylene diisocyanate; cycloaliphatic diisocyanates, such as cyclohexane 1,3-diisocyanate and cyclohexane 1,4-diisocyanate and also any desired mixtures thereof, 1-isocyanato-3,3,5-trimethyl-5-isocyanatomethylcyclohexane (IPDI), 2,4- and 2,6-hexahydrotolylene diisocyanate and also the corresponding isomeric mixtures, 4,4′-, 2,2′- and 2,4′-dicyclohexylmethane diisocyanate and also the corresponding isomeric mixtures, and preferably aromatic di- and polyisocyanates, for example 2,4- and 2,6-tolylene diisocyanate and the corresponding isomeric mixtures, 4,4′-, 2,4′- and 2,2′-diphenylmethane diisocyanate and the corresponding isomeric mixtures, mixtures of 4,4′- and 2,2′-diphenylmethane diisocyanates, polyphenylpolymethylene polyisocyanates, mixtures of 4,4′-, 2,4′- and 2,2′-diphenylmethane diisocyanates and polyphenylpolymethylene polyisocyanates (crude MDI) and mixtures of crude MDI and tolylene diisocyanates.

Organic di- and polyisocyanates can be used individually or in the form of their mixtures.

Preference is given to using tolylene diisocyanate, mixtures of diphenylmethane diisocyanate isomers, mixtures of diphenylmethane diisocyanate and crude MDI or tolylene diisocyanate with diphenylmethane diisocyanate and/or crude MDI. Particular preference is given to using mixtures of diphenylmethane diisocyanate isomers with at least 30% by weight proportions of 2,4′-diphenylmethane diisocyanate.

Use is frequently also made of so-called modified polyfunctional isocyanates, i.e., products obtained by chemical reaction of organic di- and/or polyisocyanates. Examples are di- and/or polyisocyanates comprising ester, urea, biuret, allophanate, carbodiimide, isocyanurate, uretdione and/or urethane groups. Specifically useful are for example: organic, preferably aromatic, polyisocyanates comprising urethane groups and having NCO contents of 43% to 5% by weight and preferably of 33% to 11% by weight, based on the total weight; 4,4′-diphenylmethane diisocyanate modified by reaction with, for example, low molecular weight diols, triols, dialkylene glycols, trialkylene glycols or polyoxyalkylene glycols having average molecular weights up to 6000 g/mol and especially having average molecular weights up to 1500 g/mol, 4,4′- and 2,4′-diphenylmethane diisocyanate mixtures modified by reaction with, for example, low molecular weight diols, triols, dialkylene glycols, trialkylene glycols or polyoxyalkylene glycols having average molecular weights up to 6000 g/mol and especially having average molecular weights up to 1500 g/mol, crude MDI modified by reaction with, for example, low molecular weight diols, triols, dialkylene glycols, trialkylene glycols or polyoxyalkylene glycols having average molecular weights up to 6000 g/mol and especially having average molecular weights up to 1500 g/mol, or 2,4- or 2,6-tolylene diisocyanate modified by reaction with, for example, low molecular weight diols, triols, dialkylene glycols, trialkylene glycols or polyoxyalkylene glycols having average molecular weights up to 6000 g/mol and especially having average molecular weights up to 1500 g/mol. The di- and/or polyoxyalkylene glycols may be used in this reaction individually or as mixtures, specific examples being: diethylene glycol, dipropylene glycol, polyoxyethylene, polyoxypropylene and polyoxypropylene-polyoxyethylene glycols, triols and/or tetrols. Also suitable are NCO-containing prepolymers having NCO contents of 2% to 35% by weight and preferably of 5% to 28% by weight, based on the total weight, prepared from polyester and/or preferably polyether polyols and 4,4′-diphenylmethane diisocyanate, mixtures of 2,4′- and 4,4′-diphenylmethane diisocyanate, 2,4- and/or 2,6-tolylene diisocyanates or crude MDI. Also suitable are liquid polyisocyanates comprising carbodiimide groups and/or isocyanurate rings and having NCO contents of 43% to 5% by weight and preferably 33% to 11% by weight, based on the total weight, for example on the basis of 4,4′-, 2,4′- and/or 2,2′-diphenylmethane diisocyanate and/or 2,4- and/or 2,6-tolylene diisocyanate.

Modified polyisocyanates, according to the present invention, may also be mixed with each or one another or with unmodified organic polyisocyanates such as, for example, 2,4′- and 4,4′-diphenylmethane diisocyanate, crude MDI, 2,4- and/or 2,6-tolylene diisocyanate.

Of particular suitability for use as modified organic polyisocyanates are NCO-containing prepolymers which are advantageously formed from the reaction of isocyanates with polyols and also optionally further compounds having isocyanate-reactive functional groups.

In addition to the above-described dispersions according to the present invention, optionally further compounds having isocyanate-reactive hydrogen atoms are added.

Possible compounds for this include for example compounds having at least two reactive hydrogen atoms. It is advantageous to use those having a functionality of 2 to 8 and preferably 2 to 6 and an average molecular weight of 200 to 12 000 g/mol and preferably of 300 to 6000 g/mol. The hydroxyl number of the polyhydroxyl compounds is generally from 10 to 1000 mg KOH/g and preferably from 25 to 500 mg KOH/g.

The compilation of polyols for the preparation of polyurethanes is already described above.

Suitable polyester polyols are obtainable for example from organic dicarboxylic acids having 2 to 12 carbon atoms, preferably aliphatic dicarboxylic acids having 4 to 6 carbon atoms, polyhydric alcohols, preferably diols, having 2 to 12 carbon atoms, preferably 2 to 6 carbon atoms, by customary methods. Typically, the organic polycarboxylic acids and/or derivatives and polyhydric alcohols are advantageously polycondensed in a molar ratio of from 1:1 to 1:1.8 and preferably of from 1:1.05 to 1:1.2, without a catalyst or preferably in the presence of esterification catalysts, advantageously in an atmosphere of inert gas, for example nitrogen, carbon monoxide, helium, argon and so forth, in the melt at temperatures of 150 to 250° C. and preferably 180 to 220° C., under reduced pressure, optionally, to the desired acid number which is advantageously less than 10 and preferably less than 2.

Useful hydroxyl-containing polyacetals include for example the compounds obtainable from glycols, such as diethylene glycol, triethylene glycol, 4,4′-dihydroxyethoxydiphenyldimethylmethane, hexanediol and formaldehyde. Suitable polyacetals are also obtainable by polymerization of cyclic acetals. Useful hydroxyl-containing polycarbonates include those of the type known per se, which are obtainable for example by reaction of diols, such as 1,3-propanediol, 1,4-butanediol and/or 1,6-hexanediol, diethylene glycol, triethylene glycol or tetraethylene glycol with diaryl carbonates, for example diphenyl carbonate, or phosgene. Useful polyester amides include for example those predominantly linear condensates obtained from polybasic, saturated and/or unsaturated carboxylic acids or anhydrides thereof and polyfunctional saturated and/or unsaturated aminoalcohols or mixtures of polyfunctional alcohols and aminoalcohols and/or polyamines. Suitable polyether polyamines are also obtainable from the abovementioned polyether polyols by known methods. By way of example there may be mentioned the cyanoalkylation of polyoxyalkylene polyols and subsequent hydrogenation of the nitrile formed, or the partial or complete amination of polyoxyalkylene polyols with amines or ammonia in the presence of hydrogen and catalysts.

The polyhydroxy compounds can be used individually or in the form of mixtures.

Polyurethanes are obtainable according to the present invention with or without use of chain-extending and/or crosslinking agents. Useful chain-extending and/or crosslinking agents include diols and/or triols having molecular weights less than 600 g/mol, preferably 62 to 400 g/mol and more preferably up to 200 g/mol. Possibilities include for example aliphatic, cycloaliphatic and/or araliphatic diols having 2 to 14 and preferably 4 to 10 carbon atoms, e.g., 1,3,-propanediol, 1,2-propanediol, 2-methyl-1,3-propanediol, 3-methyl-1,5-pentanediol, neopentylglycol, pentanediol, tripropylene glycol, 1,10-decanediol, o-dihydroxycyclohexane, m-dihydroxycyclohexane, p-dihydroxycyclohexane, diethylene glycol, dipropylene glycol and preferably ethylene glycol, 1,4-butanediol, 1,6-hexanediol and bis(2-hydroxyethyl)hydroquinone, triols, such as 1,2,4- and 1,3,5-trihydroxycyclohexane, triethanolamine, diethanolamine, glycerol and trimethylolpropane and low molecular weight hydroxyl-containing polyalkylene oxides based on ethylene oxide and/or 1,2-propylene oxide and the aforementioned diols and/or triols as starter molecules.

When polyurethanes are prepared according to the present invention by using chain-extending agents, crosslinking agents or mixtures thereof, these are advantageously used in amounts of 1% to 60% by weight, preferably 1.5% to 50% by weight and especially 2% to 40% by weight, based on the weight of the sum total of the polyol compounds.

Polyurethane foams are prepared in the further presence of blowing agents and/or water. Useful blowing agents in addition to water include generally known chemically and/or physically acting compounds. Chemical blowing agents are compounds which react with isocyanate to form gaseous products, for example water or formic acid. Physical blowing agents are compounds which are dissolved or emulsified in the feedstocks of polyurethane production and vaporize under the conditions of polyurethane formation. They are for example hydrocarbons, halogenated hydrocarbons, and other compounds, for example perfluorinated alkanes, such as perfluorohexane, chlorofluorocarbons, and ethers, esters, ketones, acetals and also organic and inorganic compounds which release nitrogen on heating, or mixtures thereof, for example (cyclo)aliphatic hydrocarbons having 4 to 8 carbon atoms, or hydrofluorocarbons, such as Solkane® 365 mfc from Solvay Fluorides LLC.

Useful catalysts include any catalyst customary for polyurethane synthesis. Such catalysts are described for example in “Kunststoffhandbuch, volume 7, Polyurethanes”, Carl Hanser Verlag, 3rd edition, 1993, chapter 3.4.1. Possibilities include for example organometallic compounds, preferably organotin compounds, such as tin(II) salts of organic carboxylic acids, e.g., tin(II) acetate, tin(II) octoate, tin(II) ethylhexanoate and tin(II) laurate, and the dialkyltin(IV) salts of organic carboxylic acids, e.g., dibutyltin diacetate, dibutyltin dilaurate, dibutyltin maleate and dioctyltin diacetate, and also bismuth carboxylates, such as bismuth(III) neodecanoate, bismuth 2-ethylhexanoate and bismuth octanoate or mixtures. Possible catalysts further include strongly basic amine catalysts. Examples thereof are amidines, such as 2,3-dimethyl-3,4,5,6-tetrahydropyrimidine, tertiary amines, such as triethylamine, tributylamine, dimethylbenzylamine, N-methyl morpholine, N-ethyl-N-cyclohexylmorpholine, N,N,N,N′-tetramethylethylenediamine, N,N,N′,N′-tetramethylbutanediamine, N,N,N′,N′-tetramethylhexanediamine, pentamethyldiethylenetriamine, tetramethyldiaminoethyl ether, bis(dimethylaminopropyl)urea, dimethylpiperazine, 1,2-dimethylimidazole, 1-azabicyclo(3,3,0)octane and preferably 1,4-diazabicyclo(2,2,2)octane and alkanolamine compounds, such as triethanolamine, triisopropanolamine, N-methyldiethanolamine, N-ethyldiethanolamine and dimethylethanolamine. Catalysts can be used individually or as mixtures. Optionally, mixtures of metal catalysts and basic amine catalysts are used as catalysts.

Useful catalysts further include especially when a comparatively large excess of polyisocyanate is used: tris(dialkylaminoalkyl)-s-hexahydrotriazines, preferably tris(N,N-dimethylaminopropyl)-s-hexahydrotriazine, tetraalkylammonium hydroxides, such as tetramethylammonium hydroxide, alkali metal hydroxides, such as sodium hydroxide, and alkali metal alkoxides, such as sodium methoxide and potassium isopropoxide, and also alkali metal salts of long-chain fatty acids having 10 to 20 carbon atoms and optionally lateral hydroxyl groups.

Preference is given to using from 0.001% to 5% by weight, especially from 0.05% to 2% by weight of catalyst or catalyst combination, based on the weight of the building block components.

The reaction mixture for preparing polyurethanes in the manner which is in accordance with the present invention may optionally include still further auxiliaries and/or added substances. Examples which may be mentioned are flame retardants, stabilizers, fillers, dyes, pigments and hydrolysis control agents and also fungistats and bacteriostats.

Suitable flame retardants include for example tricresyl phosphate, tris(2-chloroethyl) phosphate, tris(2-chloropropyl) phosphate, tetrakis(2-chloroethyl)ethylenediphosphate, dimethyl methanephosphonate, diethyl diethanolaminomethylphosphonate and also commercially available halogenated and halogen-free flame retardants. In addition to the halogen-substituted phosphates already mentioned it is also possible to use organic or inorganic flame retardants, such as red phosphorus, aluminum oxide hydrate, antimony trioxide, arsenic oxide, ammonium polyphosphate and calcium sulfate, expandable graphite or cyanuric acid derivatives, e.g., melamine, or mixtures of at least two flame retardants, for example ammonium polyphosphates and melamine and also optionally maize starch or ammonium polyphosphate, melamine and expandable graphite and/or optionally aromatic polyesters for rendering the polyisocyanate polyaddition products flame retardant. Additions of melamine will prove particularly efficacious here. It will generally prove advantageous to use from 5% to 50% by weight and preferably from 5% to 30% by weight of the recited flame retardants for every 100% by weight of other components used.

Useful stabilizers include more particularly surface-active substances, i.e., compounds which serve to augment the homogenization of starting materials and may in some cases also be suitable for regulating the cellular structure of the polyurethane. Examples which may be mentioned are emulsifiers, such as the sodium salts of castor oil sulfates or fatty acids and also salts of fatty acids with amines, for example the salt of oleic acid with diethylamine, the salt of stearic acid with diethanolamine, the salt of ricinoleic acid with diethanolamine, salts between sulfonic acids, for example alkali metal salts or ammonium salts of dodecylbenzene- or dinaphthylmethanedisulfonic acid and ricinoleic acid; foam stabilizers, such as siloxane-oxalkylene copolymers and other organopolysiloxanes, ethoxylated alkylphenols, ethoxylated fatty alcohols, paraffin oils, castor oil esters, ricinoleic esters, Turkey red oil and peanut oil, and cell regulators, such as paraffins, fatty alcohols and dimethylpolysiloxanes. The stabilizers used are predominantly organopolysiloxanes that are soluble in water. These are polydimethylsiloxane moieties grafted with a polyether chain formed from ethylene oxide and propylene oxide. The surface-active substances are typically used in amounts of 0.01% to 5% by weight, based on 100% by weight of the other components used.

Useful fillers, especially reinforcing fillers, include customary organic and inorganic fillers known per se, reinforcing agents, weighting agents, agents for improving the abrasion behavior in paints, coating compositions, etc. Specific examples are: inorganic fillers, such as siliceous minerals, for example sheet-silicates, such as antigorite, serpentine, hornblends, ampiboles, chrysotil and talc, metal oxides, such as kaolin, aluminum oxides, titanium oxides and iron oxides, metal salts, such as chalk, barite and inorganic pigments, such as cadmium sulfide and zinc sulfide, and also glass and so forth. Preference is given to using kaolin (china clay), aluminum silicate and coprecipitates of barium sulfate and aluminum silicate and also natural and synthetic fibrous minerals, such as wollastonite, metal fibers and especially glass fibers of differing length, which may each optionally be coated with a size. Useful organic fillers include for example: carbon, rosin, cyclopentadienyl resins and graft polymers and also cellulosic fibers, polyamide, polyacrylonitrile, polyurethane, polyester fibers based on aromatic and/or aliphatic dicarboxylic esters and especially carbon fibers. Organic and inorganic fillers can be used individually or as mixtures and are advantageously incorporated in the reaction mixture in amounts of 0.5% to 50% by weight and preferably 1% to 40% by weight, based on the weight of the other components used, although the proportion of mats, nonwovens and wovens composed of natural and synthetic fibers can reach values up to 80% by weight.

Further particulars about the abovementioned other customary auxiliary and added substances are discernible from the scholarly literature, for example from the monograph by J. H. Saunders and K. C. Frisch “High Polymers” volume XVI, “Polyurethanes”, parts 1 and 2, Interscience Publishers 1962 and 1964 respectively, or the above-cited Kunststoffhandbuch, “Polyurethanes”, volume VII, Hanser-Verlag Munich, Vienna, 1st to 3rd edition.

Polyurethanes according to the present invention are prepared by reacting the organic and/or modified organic polyisocyanates, the dispersion and optionally the further compounds comprising isocyanate-reactive hydrogen atoms and also further constituents in such amounts that the equivalence ratio of NCO groups of the polyisocyanates to the sum total of reactive hydrogen atoms of the other components is less than 0.10:10 and preferably less than 0.70:5.

### EXAMPLES

Some examples follow to illustrate the invention and not in any way restrict the scope of the invention.

Viscosities were determined to ASTM D7042; OH numbers were determined to DIN 53240.

### Starting Materials:

Polyol 1: polyetherol based on dipropylene glycol, propylene oxide and ethylene oxide with an OH number of 63 mg KOH/g and a viscosity of 300 mPas at 25° C.
Polyol 2: polyetherol based on vicinal TDA as starter, ethylene oxide and propylene oxide, with a hydroxyl number of 160 mg KOH/g, and a viscosity of 650 mPas at 25° C.
Polyol 3: polyetherol based on glycerol, propylene oxide and ethylene oxide with an OH number of 56 mg KOH/g and a viscosity of 470 mPas at 25° C.
Polyol 4: polyetherol based on glycerol, propylene oxide and ethylene oxide with an OH number of 28 mg KOH/g and a viscosity of 1100 mPas at 25° C.
Polyol 5: polyetherol based on glycerol, propylene oxide and ethylene oxide with an OH number of 35 mg KOH/g and a viscosity of 850 mPas at 25° C.
Polyol 6: PolyTHF® 2000 is a two-functional polyetherol prepared by polymerization of tetrahydrofuran and having a hydroxy number of 56 mg KOH/g.
Polyol 7: T 5000 polyetheramine is a three-functional, primary amine having an average molecular weight of 5000 g/mol and an amine number of 30 mg KOH/g.
Polyol 8: D 2000 polyetheramine is a two-functional, primary amine having an average molecular weight of 2000 g/mol and an amine number of 56 mg KOH/g.
Polyol 9: polyetherol based on glycerol, monoethylene glycol, propylene oxide and ethylene oxide with an OH number of 48 mg KOH/g and a viscosity of 540 mPas at 25° C.
Polyol 10: polymer polyetherol based on glycerol, propylene oxide and ethylene oxide, having a solids content (styrene-acrylonitrile particle, bimodal particle distribution) of 45% by weight, an OH number of 30 mg KOH/g and a viscosity of 4300 mPas at 25° C.
Polyol 11: polymer polyetherol based on glycerol, propylene oxide and ethylene oxide, having a solids content (styrene/acrylonitrile particle) of 45% by weight, an OH number of 20 mg KOH/g and a viscosity of 7400 mPas at 25° C.
Polyol 12: polyetherol based on glycerol, propylene oxide and ethylene oxide with an OH number of 27 mg KOH/g and a viscosity of 1225 mPas at 25° C.
Polyol 13: polyetherol based on propylene glycol, propylene oxide and ethylene oxide with an OH number of 29 mg KOH/g and a viscosity of 760 mPas at 25° C.
Polyol 14: polymer polyetherol based on glycerol, propylene oxide and ethylene oxide, having a solids content (styrene-acrylonitrile particle, monomodal particle distribution) of 44% by weight, an OH number of 31 mg KOH/g and a viscosity of 4500 mPas at 25° C.
Macromer 1: six-functional polyetherol having a hydroxy number of 18.4 mg of KOH/g, determined to DIN 53240, reacted with TMI® (Meta).
TMI® (Meta)=unsaturated aliphatic isocyanate from Cytec Industries
DBTL: dibutyltin dilaurate, TRIGON Chemie GmbH
Vazo® 64=free-radical initiator from DuPont
Silica polyol 1: 20% silica dispersion in polyol 1, prepared by admixing an aqueous silica sol (Levasil® 200E/20% of H.C. Starck GmbH & Co KG, Leverkusen, Germany, particle diameter based on the BET method: 15 nm, pH 2.5, silicon dioxide concentration: 20% by weight) with 1-methoxy-2-propanol and polyol 1, and then distilling off the solvent (as described in WO 2010/043530 A1).
Silica polyol 2: 30% silica dispersion in polyol 2, prepared by admixing an aqueous silica sol (Levasil® 200E/20% of H.C. Starck GmbH & Co KG, Leverkusen, Germany, particle diameter based on BET method: 15 nm, pH 2.5, silicon dioxide concentration: 20% by weight) with isopropanol and polyol 2, then distilling off the solvent, and admixing the dispersion with methyltrimethoxysilane (from Merck Schuchardt OHG, Hohenbrunn, Germany) (as described in WO 2010/043530 A1).
Silica polyol 3: 15% silica dispersion in polyol 3, prepared by admixing an aqueous silica sol (Levasil® 200E/20% of H.C. Starck GmbH & Co KG, Leverkusen, Germany, particle diameter based on the BET method: 15 nm, pH 2.5, silicon dioxide concentration: 20% by weight) with 1-methoxy-2-propanol and polyol 3, then distilling off the solvent, and admixing the dispersion with methyltrimethoxysilane (as described in WO 2010/043530 A1).
Silica polyol 4: 14% silica dispersion in polyol 4, prepared by admixing an aqueous silica sol (Levasil® 200E/20% of H.C. Starck GmbH & Co KG, Leverkusen, Germany, particle diameter based on the BET method: 15 nm, pH 2.5, silicon dioxide concentration: 20% by weight) with iso- and n-propanol and polyol 4, then distilling off the solvent, and admixing the dispersion with isobutyltriethoxysilane (from Sigma-Aldrich Chemie GmbH, Steinheim, Germany) (as described in WO 2010/043530 A1).
Silica B14: 30% silica dispersion in 1,4-butanediol (B14), prepared by admixing an aqueous silica sol (Levasil® 200E/20% of H.C. Starck GmbH & Co KG, Leverkusen, Germany, particle diameter based on BET method: 15 nm, pH 2.5, silicon dioxide concentration: 20% by weight) with the 1,4-butanediol and distilling off the water (as described in WO 2010/103072 A1).
Silica MEG: 30% silica dispersion in monoethylene glycol (MEG), prepared by admixing an aqueous silica sol (Levasil® 200E/20% of H.C. Starck GmbH & Co KG, Leverkusen, Germany, particle diameter based on BET method: 15 nm, pH 2.5, silicon dioxide concentration: 20% by weight) with MEG and distilling off the water (as described in WO 2010/103072 A1).
Silica polyol 6: 10% silica dispersion in polyol 6, prepared by admixing an aqueous silica sol (Levasil® 200E/20% of H.C. Starck GmbH & Co KG, Leverkusen, Germany, particle diameter based on BET method: 15 nm, pH 2.5, silicon dioxide concentration: 20% by weight) with isopropanol and polyol 6, then distilling off the solvent (as described in WO 2010/043530 A1).
Silica polyol 7: 10% silica dispersion in polyol 7, prepared by admixing an aqueous silica sol (Levasil® 200E/20% of H.C. Starck GmbH & Co KG, Leverkusen, Germany, particle diameter based on BET method: 15 nm, pH 2.5, silicon dioxide concentration: 20% by weight) with isopropanol and polyol 7, then distilling off the solvent, and admixing the dispersion with isobutyltriethoxysilane (from Sigma-Aldrich Chemie GmbH, Steinheim, Germany) (as described in WO 2010/043530 A1).

Levasil® 200E/20% is a 20% aqueous colloidally disperse solution of amorphous silicon dioxide (SiO₂) from H.C. Starck GmbH & Co. KG.

Aerosil® R 8200 is a structurally modified hexamethyldisilazane-aftertreated hydrophobic pyrogenous silica from Evonik Degussa GmbH.

Aerosil® 200 is a hydrophilic pyrogenous silica from Evonik Degussa GmbH.

Luran® VLN is a styrene-acrylonitrile copolymer.

Particle size distributions were measured using a Malvern Mastersizer. The meanings of the individual values are as follows:

D10: 10% of all particles by volume have a diameter smaller than the stated value
D50: 50% of all particles by volume have a diameter smaller than the stated value
D90: 90% of all particles by volume have a diameter smaller than the stated value

Mastersizer (measurement of particle size distribution): Mastersizer 2000 (principle of static light scattering); samples were diluted with isopropanol to the concentration required for measurement.

### Example 1

### Preparation of Dispersion 1

402.3 g of polyol 1 and 37.5 g of silica polyol 1 were initially charged to a stirred autoclave and heated to 110° C. Then, 175 g of acrylonitrile, 350 g of styrene, 5.5 g of dodecanethiol, 2.6 g of Vazo® 64 and 37.5 g of silica polyol 1 dissolved in 429.4 g of polyol 1 were metered into the reaction mixture over 150 minutes. After a reaction time of 15 minutes, the product was freed of residual monomer at 15 mbar by applying a vacuum. The polymer polyol obtained had a viscosity of 3707 mPas at 25° C., determined to ASTM D7042. Particle size distribution: D10=0.792 μm, D50=1.005 μm and D90=1.250 μm.

### Example 2

### Preparation of Dispersion 2

363.5 g of polyol 1 and 60 g of silica polyol 1 were initially charged to a stirred autoclave and heated to 100° C. Then, 300 g of acrylonitrile, 3.2 g of dodecanethiol, 3 g of Vazo® 64 and 60 g of silica polyol 1 dissolved in 389.4 g of polyol 1 were metered into the reaction mixture over 150 minutes. After a reaction time of 30 minutes, the product was freed of residual monomer at 15 mbar by applying a vacuum. The polymer polyol obtained had a viscosity of 16 509 mPas at 25° C., determined to ASTM D7042. Particle size distribution: D10=0.783 μm, D50=2.675 μm and D90=7.340 μm.

### Example 3

### Preparation of Dispersion 3

262.2 g of 1,4-butanediol and 50 g of silica B14 were initially charged to a stirred autoclave and heated to 100° C. Then, 116.7 g of acrylonitrile, 233.3 g of styrene, 3.5 g of dodecanethiol, 3.5 g of Vazo® 64 and 50 g of silica B14 dissolved in 280.9 g of 1,4-butanediol were metered into the reaction mixture over 150 minutes. After a reaction time of 15 minutes, the product was freed of residual monomer at 50 mbar by applying a vacuum. The polymer polyol obtained had a viscosity of 111 mPas at 25° C., determined to ASTM D7042. Particle size distribution: D10=1.463 μm, D50=4.228 μm and D90=8.547 μm.

### Example 4

### Preparation of Dispersion 4

374.7 g of MEG and 50 g of silica MEG were initially charged to a stirred autoclave and heated to 90° C. Then, 150 g of acrylonitrile, 1.6 g of dodecanethiol, 1.5 g of Vazo® 64 and 50 g of silica MEG dissolved in 399.7 g of MEG were metered into the reaction mixture over 150 minutes. After a reaction time of 60 minutes, the product was freed of residual monomer at 50 mbar by applying a vacuum. The polymer polyol obtained had a viscosity of 722 mPas at 25° C., determined to ASTM D7042. Particle size distribution: D10=2.470, D50=7.437 μm and D90=11.801 μm.

### Example 5

### Preparation of Dispersion 5

A mixture of 103.8 g of polyol 6, 150 g of silica polyol 6, 20 g of acrylonitrile, 40 g of styrene, 0.6 g of dodecanethiol and 0.6 g of Vazo® 64 was initially charged to a stirred autoclave, heated to 80° C. and stirred for 4 hours. Then, the product was freed of residual monomer by applying a vacuum at 15 mbar and 120° C. The polymer polyol obtained had a viscosity of 1018 mPas at 60° C., determined to ASTM D7042. Particle size distribution: D10=0.875 μm, D50=2.673 μm and D90=4.950 μm.

### Example 6

### Preparation of Dispersion 6

A mixture of 223.8 g of polyol 7, 75 g Levasil® 200E/20%, 20 g of acrylonitrile, 40 g of styrene, 0.6 g of dodecanethiol and 0.6 g of Vazo® 64 was initially charged to a stirred autoclave, heated to 80° C. and stirred for 4 hours. Then, the product was freed of residual monomer by applying a vacuum at 15 mbar and 120° C. The polymer polyol obtained had a viscosity of 9095 mPas at 25° C., determined to ASTM 07042. Particle size distribution: D10=0.470 μm, D50=0.985 μm and D90=7.547 μm.

### Example 7

### Preparation of Dispersion 7

8.7 g of polyol 7 and 300.0 g of 10% silica polyol 7 were initially charged to a stirred autoclave and heated to 125° C. Then, 290.6 g of styrene, 145.3 g of acrylonitrile, 4.6 g of dodecanethiol and 2.0 g of Vazo® 64 dissolved in 278.8 g of polyol 7 were metered into the reaction mixture over 150 minutes. After a reaction time of 10 minutes, the product was freed of residual monomer by applying a vacuum at 10 mbar. The polymer polyol obtained had a viscosity of 8876 mPas at 25° C., determined to ASTM D7042. Particle size distribution: D10=0.358, D50=0.746 μm and D90=4.568 μm.

### Example 8

### Preparation of Dispersion 8

A mixture of 223.8 g of polyol 8, 75 g Levasil® 200E/20%, 20 g of acrylonitrile, 40 g of styrene, 0.6 g of dodecanethiol and 0.6 g of Vazo® 64 was initially charged to a stirred autoclave, heated to 80° C. and stirred for 4 hours. Then, the product was freed of residual monomer by applying a vacuum at 15 mbar and 120° C. The polymer polyol obtained had a viscosity of 3707 mPas at 25° C., determined to ASTM D7042. Particle size distribution: D10=0.792 μm, D50=1.005 μm and D90=1.250 μm.

### Example 9

### Preparation of Dispersion 9

A mixture of 408.5 g of polyol 5, 15 g of Aerosil® R 8200, 75 g of acrylonitrile, 0.75 g of dodecanethiol and 0.75 g of Vazo® 64 was initially charged to a stirred autoclave, heated to 80° C. and stirred for 4 hours. Then, the product was freed of residual monomer by applying a vacuum at 15 mbar and 120° C. The polymer polyol obtained had a viscosity of 2058 mPas at 25° C., determined to ASTM 07042.

### Example 10

### Preparation of Dispersion 10

A mixture of 383 g of polyol 5, 15 g of Aerosil® 200, 33.3 g of acrylonitrile, 66.7 g of styrene, 1 g of dodecanethiol and 1 g of Vazo® 64 was initially charged to a stirred autoclave, heated to 80° C. and stirred for 4 hours. Then, the product was freed of residual monomer by applying a vacuum at 15 mbar and 120° C. The polymer polyol obtained had a viscosity of 1722 mPas at 25° C., determined to ASTM D7042.

### Example 11

### Preparation of Dispersion 11

319.2 g of polyol 2 and 166.7 g of silica polyol 2 were initially charged to a stirred autoclave and heated to 110° C. Then, 66.7 g of acrylonitrile, 133.3 g of styrene, 2.0 g of dodecanethiol, 2.0 g of Vazo® 64 dissolved in 310.1 g of polyol 2 were metered into the reaction mixture over 150 minutes. After a reaction time of 15 minutes, the product was freed of residual monomer by applying a vacuum at 7 mbar. The polymer polyol obtained had a viscosity of 1668 mPas at 25° C., determined to ASTM D7042. Particle size distribution: D10=0.602 μm, D50=0.896 μm and D90=1.313 μm.

### Example 12

### Preparation of Dispersion 12

280.5 g of polyol 2 and 250 g of silica polyol 2 were initially charged to a stirred autoclave and heated to 110° C. Then, 200 g of acrylonitrile, 400 g of styrene, 6.0 g of dodecanethiol, and 6.0 g of Vazo® 64 dissolved in 357.5 g of polyol 2 were metered into the reaction mixture over 150 minutes. After a reaction time of 15 minutes, the product was freed of residual monomer by applying a vacuum at 16 mbar. The polymer polyol obtained had a viscosity of 6982 mPas at 25° C., determined to ASTM D7042. Particle size distribution: D10=0.959 μm, D50=1.300 μm and D90=1.721 μm.

### Example 13

### Preparation of Dispersion 13

609.4 g of polyol 2, 133.3 g of silica polyol 2 and 40 g of macromer 1 were initially charged to a stirred autoclave and heated to 110° C. Then, 200 g of acrylonitrile, 200 g of styrene, 4.0 g of dodecanethiol, 4.0 g of Vazo® 64 and 20 g of macromer 1 dissolved in 789.3 g of polyol 2 were metered into the reaction mixture over 150 minutes. After a reaction time of 15 minutes, the product was freed of residual monomer by applying a vacuum at 7 mbar. The polymer polyol obtained had a viscosity of 2370 mPas at 25° C., determined to ASTM D7042. Particle size distribution: D10=0.254 μm, D50=0.332 μm and D90=0.88 μm.

### Example 14

### Preparation of Dispersion 14

189.5 g of polyol 2, 666.7 g of silica polyol 2 and 20 g of macromer 1 were initially charged to a stirred autoclave and heated to 110° C. Then, 100 g of acrylonitrile, 100 g of styrene, 2.0 g of dodecanethiol, 2.0 g of Vazo® 64 and 10 g of macromer 1 dissolved in 909.8 g of polyol 2 were metered into the reaction mixture over 150 minutes. After a reaction time of 15 minutes, the product was freed of residual monomer by applying a vacuum at 7 mbar. The polymer polyol obtained had a viscosity of 1377 mPas at 25° C., determined to ASTM D7042. Particle size distribution: D10=0.245 μm, D50=0.315 μm and D90=0.431 μm.

### Example 15

### Preparation of Dispersion 15

310.5 g of polyol 2, 333.3 g of silica polyol 2 and 40 g of macromer 1 were initially charged to a stirred autoclave and heated to 110° C. Then, 200 g of acrylonitrile, 400 g of styrene, 6.0 g of dodecanethiol, 6.0 g of Vazo® 64 and 20 g of macromer 1 dissolved in 684.2 g of polyol 2 were metered into the reaction mixture over 150 minutes. After a reaction time of 15 minutes, the product was freed of residual monomer by applying a vacuum at 7 mbar. The polymer polyol obtained had a viscosity of 6118 mPas at 25° C., determined to ASTM D7042. Particle size distribution: D10=0.397 μm, D50=0.547 μm and D90=0.955 μm.

### Example 16

### Preparation of Dispersion 16

A reactor equipped with a multiple blade stirrer was initially charged with 90 g of polyol 2 and also 15 g of silica polyol 2 and 45 g of Luran® VLN. The reactor was purged with nitrogen and thereafter the mixture was heated to 210° C. On attainment of the temperature the stirrer speed was set to 900 min⁻¹ for 30 minutes' stirring. The product was then cooled down to 35° C. and discharged. The polymer polyol obtained had a viscosity of 1980 mPas at 25° C., determined to ASTM D7042. Particle size distribution: D10=0.650 μm, D50=2.538 μm and D90=7.760 μm.

### Example 17

### Preparation of Dispersion 17

631.4 g of polyol 4 and 266.7 g of silica polyol 4 were initially charged to a stirred autoclave and heated to 110° C. Then, 125.0 g of acrylonitrile, 125.0 g of styrene, 2.4 g of dodecanethiol, 2.4 g of Vazo® 64 and 1347.2 g of polyol 4 were metered into the reaction mixture over 150 minutes. After a reaction time of 15 minutes, the product was freed of residual monomer by applying a vacuum at 8 mbar. The polymer polyol obtained had a viscosity of 2889 mPas at 25° C., determined to ASTM D7042. Particle size distribution: D10=0.141 μm, D50=0.284 μm and D90=1.486 μm.

### Example 18

### Preparation of Dispersion 18

696.4 g of polyol 3, 333.3 g of silica polyol 3, 179.5 g of polyol 14 and 25.2 g of macromer 1 were initially charged to a stirred autoclave and heated to 110° C. Then, 333.3 g of acrylonitrile, 666.7 g of styrene, 10.5 g of dodecanethiol, 4.6 g of Vazo® 64 and 23.2 g of macromer 1 dissolved in 456.77 g of polyol 3 were metered into the reaction mixture over 150 minutes. After a reaction time of 15 minutes, the product was freed of residual monomer by applying a vacuum at 6 mbar. The polymer polyol obtained had a viscosity of 7408 mPas at 25° C., determined to ASTM D7042. Particle size distribution: D10=0.440 μm, D50=1.299 μm and D90=5.453 μm.

### Example 19

### Comparative Example Versus Example 3

262.2 g of 1,4-butanediol and 35 g of macromer 1 were initially charged to a stirred autoclave and heated to 100° C. Then, 116.7 g of acrylonitrile, 233.3 g of styrene, 3.5 g of dodecanethiol, and 3.5 g of Vazo® 64 dissolved in 280.9 g of 1,4-butanediol were metered into the reaction mixture over 150 minutes. Even as the reaction is ongoing, there is polyol/SAN phase separation and deposition of SAN polymer on the stirrer. It proved impossible to prepare a stable dispersion.

### Example 20

### Comparative Example Versus Example 3

262.2 g of 1,4-butanediol were initially charged to a stirred autoclave and heated to 100° C. Then, 116.7 g of acrylonitrile, 233.3 g of styrene, 3.5 g of dodecanethiol, and 3.5 g of Vazo® 64 dissolved in 280.9 g of 1,4-butanediol were metered into the reaction mixture over 150 minutes. Even as the reaction is ongoing, there is polyol/SAN phase separation and deposition of SAN polymer on the stirrer. It proved impossible to prepare a stable dispersion.

### Example 21

### Comparative Example Versus Example 4

374.7 g of MEG and 35 g of macromer 1 were initially charged to a stirred autoclave and heated to 90° C. Then, 150 g of acrylonitrile, 1.6 g of dodecanethiol, and 1.5 g of Vazo® 64 dissolved in 399.7 g of MEG were metered into the reaction mixture over 150 minutes. Even as the reaction is ongoing, there is polyol/SAN phase separation and deposition of SAN polymer on the stirrer. It proved impossible to prepare a stable dispersion.

### PU1. Use of Inventive Dispersions for Production of Polyurethane Foams

Samples for mechanical testing were produced using methods customary in the polyurethane industry. The isocyanate was added to the efficiently commixed and homogenized blend of dispersion and other polyurethane formulation feedstocks. The formulations were poured into an open mold, allowed to react and cured at room temperature. Mechanical properties were determined on test specimens cut out of the center of the foam block, in accordance with standard test methods. The values were specified as follows: compression strain to DIN EN ISO 3386, compression set to DIN EN ISO 1856, tensile strength and elongation at break to DIN EN ISO 1798, rebound resilience to DIN EN ISO 8307, tongue tear resistance to DIN ISO 34-1, B(b).

### Example A1

### Producing a Flexible Foam Comprising Polyol 10 (Reference Example)

To 349.1 g of polyol 9 and 116.4 g of polyol 10 were added 4.65 g of a silicone-containing surfactant (Tegostab® B4900), 0.84 g of a 33% by weight solution of 1,4-diazabicyclo[2.2.2]octane in DPG (Dabco® 33LV), 0.28 g of a 70% by weight solution of bis(N,N-dimethylaminoethyl)ether in DPG (Niax® A1) and 11.2 g of water. The blend obtained was mixed with a laboratory stirrer and then left at room temperature for 30 minutes. 0.84 g of tin(II) octoate (Kosmos® 29) was added, the mixture was briefly stirred, and 166.7 g of Lupranat® T 80 A (a mixture of 2,4-TDI and 2,6-TDI in a ratio of 80/20 with an NCO value of 48.2%) were added. After stirring with a laboratory stirrer at 1500 rpm for 10 seconds, the mixture was poured into an open mold, left to react and cured at room temperature to obtain an 11 L foam block. After complete curing at room temperature for a period of 24 hours, the foam was demolded, and the mechanical properties were determined.

### Example A2

### Producing a Flexible Foam Comprising Dispersion 18

To 349.1 g of polyol 9 and 116.4 g of dispersion 18 were added 4.65 g of a silicone-containing surfactant (Tegostab® B4900), 0.84 g of a 33% by weight solution of 1,4-diazabicyclo[2.2.2]octane in DPG (Dabco® 33LV), 0.28 g of a 70% by weight solution of bis(N,N-dimethylaminoethyl)ether in DPG (Niax® A1) and 11.2 g of water. The blend obtained was mixed with a laboratory stirrer and then left at room temperature for 30 minutes. 0.84 g of tin(II) octoate (Kosmos® 29) was added, the mixture was briefly stirred, and 166.7 g of LupranatT® 80 A (a mixture of 2,4-TDI and 2,6-TDI in a ratio of 80/20 with an NCO value of 48.2%) were added. After stirring with a laboratory stirrer at 1500 rpm for 10 seconds, the mixture was poured into an open mold, left to react and cured at room temperature to obtain an 11 L foam block. After complete curing at room temperature for a period of 24 hours, the foam was demolded, and the mechanical properties were determined.

As is discernible from Table 1, adding dispersion 18 improves the mechanical properties.

TABLE 1

| | Unit | Example A1 | Example A2 |
|---|---|---|---|
| cream time | s | 12 | 13 |
| fiber time | s | 92 | 112 |
| blowing-off time | s | 126 | 150 |
| density | kg/m³ | 38.7 | 40.2 |
| compression strain at 40% compression | kPa | 6.4 | 6.0 |
| compression set 50% | % | 2.9 | 2.7 |
| tensile strength | kPa | 73 | 82 |
| elongation at break | % | 75 | 89 |
| rebound resilience | % | 40 | 41 |
| tongue tear resistance | N/mm | 0.53 | 0.76 |

### PU2. Use of Inventive Dispersions for Production of Polyurethane Elastomers

Samples for mechanical testing were produced using methods customary in the polyurethane industry. The values were determined as follows: density to DIN EN ISO 1183-1A, Shore A hardness to DIN 53505, tensile strength and elongation at break to DIN 53504, tongue tear resistance to DIN ISO 34-1, B(b), abrasion to DIN ISO 4649.

### Example B1

### Production of Polyurethane Elastomers (Reference Example)

To 175.4 g of polyol 4 and 7.05 g of 1,4-butanediol was added a mixture of 0.78 g of a silicone-containing surfactant (Tegostab® B4113), 0.88 g of a 33% by weight solution of 1,4-diazabicyclo[2.2.2]octane in DPG (Dabco® 33LV) and 11.7 g of K—Ca—Na zeolite paste. The mixture obtained was stirred with a high-speed mixer for 1 minute and then left at room temperature for 30 minutes. 54.1 g of a commercially available MDI prepolymer for flexible elastomers and molded flexible foams with an NCO content of 23% (Lupranat® MP 102) were added (resulting in an isocyanate index of 105) and stirred for 1 minute in a high-speed mixer, poured into an open mold, allowed to react and cured at 50° C. to form a plate measuring 200×150×6 mm. The material obtained was conditioned at 60° C. for 24 hours and the mechanical properties were determined on appropriate test specimens cut out of the central portion of the plate.

### Example B2

### Production of a Polyurethane Elastomer Comprising Polyol 11 (Reference Example)

To 140 g of polyol 4, 40.2 g of polyol 11 and 6.5 g of 1,4-butanediol was added a mixture of 0.72 g of a silicone-containing surfactant (Tegostab® B4113), 0.81 g of a 33% by weight solution of 1,4-diazabicyclo[2.2.2]octane in DPG (Dabco® 33LV) and 10.9 g of K—Ca—Na zeolite paste. The mixture obtained was stirred with a high-speed mixer for 1 minute and then left at room temperature for 30 minutes. 50.8 g of a commercially available MDI prepolymer for flexible elastomers and molded flexible foams with an NCO content of 23% (Lupranat® MP 102) were added (resulting in an isocyanate index of 105) and stirred for 1 minute in a high-speed mixer, poured into an open mold, allowed to react and cured at 50° C. to form a plate measuring 200×150×6 mm. The material obtained was conditioned at 60° C. for 24 hours and the mechanical properties were determined on appropriate test specimens cut out of the central portion of the plate.

### Example B3

### Producing a Polyurethane Elastomer Comprising Silicon Dioxide Nanoparticles (Reference Example)

27.5 g of silica polyol 4 dispersion, 149.2 g of polyol 4 and 6.9 g of 1,4-butanediol were mixed and to this mixture were added 0.77 g of a silicone-containing surfactant (Tegostab® B4113), 0.87 g of a 33% by weight solution of 1,4-diazabicyclo[2.2.2]octane in DPG (Dabco® 33LV) and 11.5 g of K—Ca—Na zeolite paste. The mixture obtained was homogenized with a high-speed mixer for 1 minute and then left at room temperature for 30 minutes. 53.2 g of Lupranat® MP 102 were added (resulting in an isocyanate index of 105) and stirred for 1 minute in a high-speed mixer, poured into an open mold, allowed to react and cured at 50° C. to form plates measuring 200×150×6 mm. The material obtained was conditioned at 60° C. for 24 hours and the mechanical properties were determined on appropriate test specimens cut out of the central portion of the plate.

### Example B4

### Producing a Polyurethane Elastomer Comprising Dispersion 17

To 181.8 g of dispersion 17 and 6.5 g of 1,4-butanediol was added a mixture of 0.72 g of a silicone-containing surfactant (Tegostab® B4113), 0.81 g of a 33% by weight solution of 1,4-diazabicyclo[2.2.2]octane in DPG (Dabco® 33LV) and 10.8 g of K—Ca—Na zeolite paste. The mixture obtained was stirred with a high-speed mixer for 1 minute and then left at room temperature for 30 minutes. 49.5 g of a commercially available MDI prepolymer for flexible elastomers and molded flexible foams with an NCO content of 23% (Lupranat® MP 102) was added and stirred for 1 minute in a high-speed mixer, poured into an open mold, allowed to react and cured at 50° C. to form a plate measuring 200×150×6 mm. The material obtained was conditioned at 60° C. for 24 hours and the mechanical properties were determined on appropriate test specimens cut out of the central portion of the plate.

The results in Table 2 show that, compared with reference example B1, the addition of standard graft polyol (B2) as well as of silica nanoparticles (B3) results in improved mechanical values. The best mechanical values are obtained on using hybrid dispersions (B4), this with approximately the same addition of organic and inorganic added substances as in Examples B2 and B3.

TABLE 2

| | Example | Example | Example | Example |
|---|---|---|---|---|
| | B1 | B2 | B3 | B4 |
| open time [min] | 4.5 | 3.5 | 5 | 3.5 |
| density [g/cm³] | 1.092 | 1.090 | 1.098 | 1.097 |
| Shore A hardness | 61 | 64 | 61 | 64 |
| tensile strength [MPa] | 4 | 7 | 4 | 10 |
| elongation at break [%] | 220 | 290 | 230 | 360 |
| tongue tear resistance | 6 | 8 | 7 | 8 |
| [kN/m] | | | | |
| abrasion [mm³] | 473 | 303 | 336 | 261 |

### PU3. Use of Inventive Dispersions for Producing Foamed Elastomers

Samples for mechanical testing were prepared using methods customary in the polyurethane industry. The values were determined as follows: tensile strength and elongation at break to DIN 53504, tongue tear resistance to DIN ISO 34-1, B(b), rebound resilience to DIN 53512.

### Starting Material:

Isocyanate 2: prepolymer from 50 parts by weight of 4,4′-diisocyanatodiphenylmethane (pure MDI), 2 parts by weight of uretonimine-modified pure MDI, 46 parts by weight of a linear propylene glycol-started polyoxypropylene etherol (OH number 55 mg KOH/mg) and 2 parts by weight of tripropylene glycol.

### Example C1

### Producing a Foamed Elastomer Comprising Dispersion 3

54.7 parts by weight of polyol 12, 30 parts by weight of polyol 13, 15 parts by weight of dispersion 3, 2.6 parts by weight of monoethylene glycol, 0.3 part by weight of silicone-based foam stabilizer (Dabco® DC 193), 0.9 part by weight of 1,4-diazabicyclo[2.2.2]octane, 0.3 part by weight of bis(2-dimethylaminopropyl)methylamine (Polycat® 77), 0.04 part by weight of organotin catalyst (Fomrez® UL 28) and 0.62 part by weight of water were mixed to form a polyol component. 100 parts by weight of the polyol component at 45° C. and 98 parts by weight of isocyanate 2 at 25° C. were mixed with one another using a Vollrath stirrer. This mixture was poured into an aluminum mold (200×200×10 mm) at 45° C., the mold was closed and the polyurethane foam thus produced was demolded after 5 minutes. The mechanical properties of the sample produced were determined after 24 hours of storage and are listed in Table 3.

TABLE 3

| Example C1 | |
|---|---|
| density [g/L] | 473 |
| hardness [Shore A] | 40 |
| tensile strength [MPa] | 2.5 |
| elongation at break [%] | 266 |
| tongue tear resistance [N/mm] | 4.0 |
| rebound resilience [%] | 35 |

### PU4. Use of Inventive Dispersions for Producing Thermoplastic Polyurethanes

Samples for mechanical testing were produced using methods customary in the polyurethane industry. The values were determined as follows: Shore D hardness to DIN 53505, tensile strength and elongation at break to DIN 53504, tongue tear resistance to DIN ISO 34-1, B(b), abrasion to DIN ISO 4649.

### Example D1

### Producing a Thermoplastic Polyurethane Comprising Dispersion 2

245 g of polyol 1, 245 g of dispersion 2, 96 g of 1,4-butanediol were weighed into a reaction vessel and heated to 90° C. Then, under agitation, 0.07 g of tin(II) octoate (Kosmos® 29) was added and at 80° C. 343.3 g of 4,4′-MDI (methylenediphenyl diisocyanate, Luptanat® ME) were added and stirring was continued until the solution was homogeneous. The reaction mass was then poured into a shallow dish and heated on a hotplate at 125° C. for 10 min. Thereafter, the hide obtained was conditioned at 80° C. in a thermal cabinet for 15 h. After pelletizing the cast plates, they were processed on an injection molding machine into 2 mm injection-molded plates. The product had a hardness of 57 Shore D, a tensile strength of 26 MPa, an elongation at break of 420%, a tongue tear resistance of 77 KN/m and an abrasion of 71 mm³.

TABLE 4
Feedstocks used in abovementioned examples

| Trade name | Producer |
|---|---|
| 1,4-butanediol | BASF |
| Lupranat ® MP 102 | BASF |
| Lupranat ® T 80 A | BASF |
| Luptanat ® ME | BASF |
| Tegostab ® B 4900 | Evonik |
| Tegostab ® B 4113 | Evonik |
| K-Ca-Na zeolite paste | UOP |
| Dabco ® 33 LV | Air products |
| Dabco ® DC 193 | Air products |
| Polycat ® 77 | Air products |
| Niax ® A1 | Momentive |
| Fomrez ® UL 28 | Momentive |
| Kosmos ® 29 | Evonik |

We claim:

1. A dispersion comprising a continuous phase (C) and a phase which is solid at 20° C. and dispersed in the continuous phase, wherein the continuous phase (C) comprises at least one compound having at least two Zerewitinoff-active hydrogen atoms, and the solid phase comprises at least one filler, wherein the filler is a hybrid material which in each case comprises at least one organic polymer (P) and at least one inorganic particle, and wherein the at least one inorganic particle has an average maximum diameter of at most 5 μm for primary particles, wherein at least one and preferably all of the dimensions of the inorganic particle is/are in the range of 1-100 nm.

2. The dispersion according to claim 1 wherein the compound having at least two Zerewitinoff-active hydrogen atoms is selected from the group comprising polyether polyols, chain extenders, polyester polyols, polyether-polyester polyols, polycarbonate polyols, polyetheramines and mixtures thereof.

3. The dispersion according to either one of claims 1 and 2 wherein the compound having at least two Zerewitinoff-active hydrogen atoms is a polyether polyol.

4. The dispersion according to any one of claims 1 to 3 wherein the compound having at least two Zerewitinoff-active hydrogen atoms is a polyether polyol having a molecular weight (Mn) of 200-12 000 g/mol and/or an OH number of 10-1000 mg KOH/g and/or a polyol starter functionality of 2-8.

5. The dispersion according to any one of claims 1 to 4 wherein the organic polymer (P) is selected from the group comprising polystyrene, poly(styrene-co-acrylonitrile), polyacrylonitrile, polyacrylate, polymethacrylate, polyolefins, polyesters, polyamide, polyvinyl chloride, polyethylene terephthalate, polyisobutylene, polyethylene glycol, polyvinyl acetate or mixtures thereof.

6. The dispersion according to any one of claims 1 to 5 wherein the inorganic particle is selected from the group of silicate materials, metal oxides, metal carbonates, inorganic salts, inorganic pigments, carbon and mixtures thereof.

7. The dispersion according to any one of claims 1 to 6 wherein the inorganic particle is a silicate, preferably silica sol.

8. A process for preparing a dispersion according to any one of claims 1 to 7, comprising the steps of:
a) heating a mixture (I) comprising at least one meltable polymer (P), at least one continuous phase (C) and at least one inorganic particle and optionally further components,
b) commixing so that at least one meltable polymer when molten is preferably present in the mixture (I) in the form of finely divided droplets,
c) cooling the mixture (I).

9. The process for preparing a dispersion according to any one of claims 1 to 7 which comprises free-radically polymerizing at least one ethylenically unsaturated monomer (A) in a continuous phase (C) in the presence of at least one inorganic particle by addition of a reaction moderator, a free-radical initiator, and optionally further components.

10. The process for preparing a dispersion according to claim 9 wherein the ethylenically unsaturated monomers (A) are selected from the group comprising styrene, alpha-methylstyrene, acrylonitrile, acrylamide, (meth)acrylic acid, (meth)acrylic esters, hydroxyalkyl(meth)acrylates, vinyl ethers, allyl ethers, divinylbenzene or mixtures thereof.

11. The process for preparing a dispersion according to any one of claims 9 to 10 wherein the continuous phase (C) comprises at least one compound having at least two Zerewitinoff-active hydrogen atoms and the compound is selected from the group recited in claim 3.

12. The process for preparing a dispersion according to claim 11 wherein the compound having at least two Zerewitinoff-active hydrogen atoms is a polyether polyol.

13. The process for preparing a dispersion according to any one of claims 10 to 12 wherein the reaction moderator is selected from the group consisting of monofunctional alcohols, alkyl mercaptans and mixtures thereof, and/or the free-radical initiator is selected from the group consisting of peroxy or azo compounds and mixtures thereof.

14. The use of a dispersion according to any one of claims 1 to 7 for production of polyurethanes, or as paint raw material for the automotive industry, as dispersion raw material for architectural coatings, sealant composition, cement, paper, textile, adhesive raw material, as power fuel additive or roof coating, for polishing of surfaces or for use in epoxy systems.

15. A process for production of polyurethanes, preferably of compact or foamed polyurethanes, which comprises reacting at least one dispersion according to any one of claims 1 to 7 with at least one polyisocyanate.
